(19) United States
(12) Patent Application Publication
(10) Pub. No.: US 2026/0258825 A1
(43) Pub. Date: Sep. 3, 2026

(54) FASTENING PINS, MULTI-PIECE FASTENERS, AND METHODS FOR FASTENING

(71) Applicant: HOWMET AEROSPACE INC., Pittsburgh, PA (US)

(72) Inventors: Troy Don Pierce, Hewitt, TX (US); Marty J. Green, Waco, TX (US); James Thomas Smith, Crawford, TX (US)

(21) Appl. No.: 19/491,250

(22) PCT Filed: May 31, 2024
(86) PCT No.: PCT/US2024/031874

§ 371 Date: Dec. 8, 2025

Related U.S. Application Data
(60) Provisional application No. 63/512,320, filed on Jul. 7, 2023.

(51) Int. Cl. F16B 5/04; F16B 19/05

(52) U.S. Cl. CPC F16B 5/04; F16B 19/05

(57) ABSTRACT

The present disclosure relates to fastening pins, multi-piece fasteners, and methods for fastening. The pin includes a first pin end, a second pin end, and a shank extending intermediate the first pin end and the second pin end. The shank includes a longitudinal axis and threads including a thread profile. The thread profile includes a first curved feature, a second curved feature, a third curved feature, a first linear feature, and a second linear feature. The first curved feature and the second curved feature form an inflection point therebetween. A radius of curvature of the second curved feature is in a range of 1.5 times greater than a radius of curvature of the third curved feature to 2.5 times greater than a radius of curvature of the third curved feature. The first linear feature has a flank angle in a range of 0 degrees to 60 degrees. degrees.

### CROSS-REFERENCE

This application claims priority to U.S. Provisional Patent Application No. 63/512,320, which was filed on Jul. 7, 2023. The contents of which is hereby incorporated by reference into this specification

### FIELD OF USE

The present disclosure relates to fastening pins, multi-piece fasteners, and methods for fastening.

### BACKGROUND

Vehicle frames, storage racks, solar panel sub-structures, aircraft parts, and other structures can include numerous mechanical fasteners. For example, a mechanical fastener can be installed in a bore of a structural component to secure parts together. Properly installing a mechanical fastener into a bore presents challenges.

### SUMMARY

According to one non-limiting aspect of the present disclosure, a fastener comprising a pin is provided. The pin comprises a first pin end, a second pin end, and a shank extending intermediate the first pin end and the second pin end. The shank comprises a longitudinal axis and threads comprising a thread profile. The thread profile comprises a first curved feature, a second curved feature, a third curved feature, a first linear feature, and a second linear feature. The first curved feature extends along the longitudinal axis and defines a first radius of curvature. The second curved feature extends along the longitudinal axis and is adjacent to the first curved feature. The first curved feature and the second curved feature form an inflection point therebetween. The second curved feature defines a second radius of curvature. The third curved feature extends along the longitudinal axis and is adjacent to the second curved feature. The third curved feature defines a third radius of curvature. At least one of the second curved feature and the third curved feature form a root of the thread profile. The second radius of curvature is in a range of 1.5 times greater than the third radius of curvature to 2.5 times greater than the third radius of curvature. The first linear feature is adjacent to the third curved feature and has a flank angle in a range of 0 degrees to 60 degrees. The second linear feature extends along the longitudinal axis and is at a crest of the thread profile.

According to one non-limiting aspect of the present disclosure, a method for fastening is provided. The method comprises inserting a pin end of a pin of a fastener into a bore of a structure. The fastener comprises the pin and a fastening collar. The pin comprises a first pin end, a second pin end, and a shank extending intermediate the first pin end and the second pin end. The shank comprises a longitudinal axis and threads comprising a thread profile. The thread profile comprises a first curved feature, a second curved feature, a third curved feature, a first linear feature, and a second linear feature. The first curved feature extends along the longitudinal axis and defines a first radius of curvature. The second curved feature extends along the longitudinal axis and is adjacent to the first curved feature. The first curved feature and the second curved feature form an inflection point therebetween. The second curved feature defines a second radius of curvature. The third curved feature extends along the longitudinal axis and is adjacent to the second curved feature. The third curved feature defines a third radius of curvature. At least one of the second curved feature and the third curved feature form a root of the thread profile. The second radius of curvature is in a range of 1.5 times greater than the third radius of curvature to 2.5 times greater than the third radius of curvature. The first linear feature is adjacent to the third curved feature and has a flank angle in a range of 0 degrees to 60 degrees. The second linear feature extends along the longitudinal axis and is at a crest of the thread profile. The method comprises forcibly contacting an elongate portion of the fastening collar of the fastener with a contact surface of an installation tool, thereby forcibly contacting the structure with a collar end of the fastening collar and deforming the elongate portion onto threads of the pin.

It will be understood that the inventions disclosed and described in this specification are not limited to the aspects summarized in this Summary. The reader will appreciate the foregoing details, as well as others, upon considering the following detailed description of various non-limiting and non-exhaustive aspects according to this specification.

### BRIEF DESCRIPTION OF THE DRAWINGS

The features and advantages of the examples, and the manner of attaining them, will become more apparent, and the examples will be better understood, by reference to the following description taken in conjunction with the accompanying drawings, wherein:

FIG. 1 is a side view of a non-limiting embodiment of a fastener according to the present disclosure;

FIG. 2 is a cross-sectional view of the area A in FIG. 1, illustrating a thread profile;

FIG. 3 is a perspective view of a non-limiting embodiment of a fastener comprising a pin and a fastening collar according to the present disclosure;

FIG. 4 is a perspective view of a non-limiting embodiment of a fastener comprising a pin and a fastening collar according to the present disclosure;

FIG. 5 is an image of a comparative fastener after installation and removal of the fastening collar from the pin, illustrating significant galling on the threads of the fastener;

FIG. 6 is an image of a non-limiting embodiment of a fastener according to the present disclosure after installation and removal of the fastening collar from the pin, illustrating minimal, if any, galling on the threads of the fastener;

FIG. 7A is an image of a thread profile of a comparative fastener prior to installation of the fastening collar on the pin;

FIG. 7B is an image of the thread profile of FIG. 7A after installation and removal of the fastening collar from the pin, illustrating significant galling on the threads;

FIG. 8A is an image of a thread profile of a non-limiting embodiment of a fastener according to the present disclosure prior to installation of the fastening collar on the pin;

FIG. 8B is an image of the thread profile of FIG. 8A after installation and removal of the fastening collar from the pin, illustrating minimal, if any, galling on the threads;

FIG. 9 is a table including results derived from removing (i) a conventional fastener, (ii) a fastener according to the present disclosure including a first coating (BL) including zinc electroplate and chromate coating, (iii) a fastener according to the present disclosure including a second coating (BLX) including the first coating and an organic topcoat with integral lube, and (iv) a fastener according to the present disclosure including a third coating (BL2X) including the first coating and two coats of an organic topcoat with integral lube;

FIG. 10A is a cross-sectional side view of a non-limiting embodiment of a multi-piece fastener and a structure according to the present disclosure;

FIG. 10B is a cross-sectional side view of the multi-piece fastener of FIG. 10A engaged with a non-limiting embodiment of a fastening collar installation tool according to the present disclosure;

FIG. 10C is a cross-sectional side view of a non-limiting embodiment of the multi-piece fastener of FIG. 10B with the fastening collar at least partially deformed onto a shank of a pin of the multi-piece fastener;

FIG. 10D is a cross-sectional side view of a non-limiting embodiment of the multi-piece fastener of FIG. 10C installed into the structure; and

FIG. 10E is a cross-sectional side view of a non-limiting embodiment of the fastening collar of FIG. 10D after removal from the pin.

Corresponding reference characters indicate corresponding parts throughout the several views. The exemplifications set out herein illustrate certain non-limiting embodiments, in one form, and such exemplifications are not to be construed as limiting the scope of the appended claims in any manner.

### DETAILED DESCRIPTION OF NON-LIMITING EMBODIMENTS

Various examples are described and illustrated herein to provide an overall understanding of the structure, function, and use of the disclosed fasteners, pins, fastening collars, and methods of fastening. The various examples described and illustrated herein are non-limiting and non-exhaustive. Thus, the invention is not limited by the description of the various non-limiting and non-exhaustive examples disclosed herein. Rather, the invention is defined solely by the claims. The features and characteristics illustrated and/or described in connection with various examples may be combined with the features and characteristics of other examples. Such modifications and variations are intended to be included within the scope of this specification. As such, the claims may be amended to recite any features or characteristics expressly or inherently described in, or otherwise expressly or inherently supported by, this specification. Further, Applicant reserves the right to amend the claims to affirmatively disclaim features or characteristics that may be present in the prior art. The various embodiments disclosed and described in this specification can comprise, consist of, or consist essentially of the features and characteristics as variously described herein.

As used herein, “intermediate” means that the referenced element is disposed between two elements but is not necessarily in contact with those elements. Accordingly, unless stated otherwise herein, an element that is “intermediate” a first element and a second element may or may not be adjacent to or in contact with the first and/or second elements, and other elements may be disposed between the intermediate element and the first and/or second elements.

Unless stated otherwise herein, a first element that is “adjacent” to a second element is in contact with the second element and another element is not between the first element and the second element.

Unless stated otherwise herein, an “inflection point” is a point on a curve at which the sign of the curvature changes. For example, a curve can change from being “concave up” to being “concave down” at an inflection point.

A lockbolt can be a two-piece fastener that includes a hardened metal pin and a metal collar that can be swaged into grooves of the pin, thereby forming a clamp force to hold assembled parts together. To install a lockbolt, an installation tool grips a pintail of the lockbolt and then pulls to close the gaps in materials being joined. Inside the nose assembly of the installation tool, a conical-shaped anvil then can be forced down the collar to progressively squeeze (e.g., swage) the collar material into the grooves of the pin. The direct metal-to-metal contact of the collar swaged into the grooves of the pin can reduce loosening effects of transverse vibration.

A standard lockbolt including a swaged collar typically can only be removed by a destructive method, such as, for example, cutting the fastening collar with a special cutter nose, cutting the fastening collar with a special collar cutter, grinding the collar, and/or cutting the fastening collar with a saw or torch. The fastening collar typically cannot be removed using standard off the shelf removal methods, such as, for example, an impact driver, a torque wrench, and/or standard driver with socket. The present disclosure provides a fastener including a thread profile that can enable the removal of the collar through conventional methods, without the need to, for example, cut or grind the fastening collar. The fastener according to the present disclosure may not require a destructive method to be removed and may reduce galling of the threads of the pin during the removal.

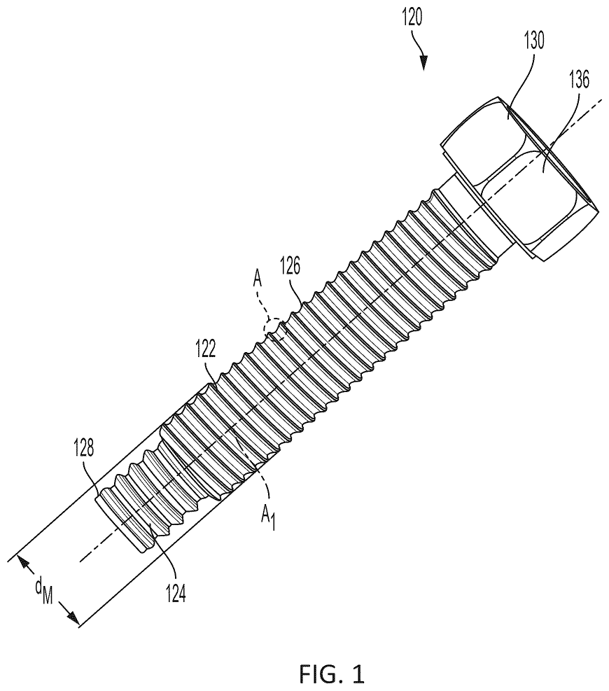

As illustrated in FIG. 1, a pin 120 can comprise a first pin end 128, a second pin end 130, a shank 122, and a longitudinal axis, A₁, extending from the first pin end 128 to the second pin end 130. The second pin end 130 can comprise a head portion 136 configured to inhibit the pin 120 from traversing into a bore in a structure beyond a predetermined distance. In various non-limiting embodiments, the pin 120 may comprise a pull region 124 (e.g., pintail) and/or a breakneck groove (not shown).

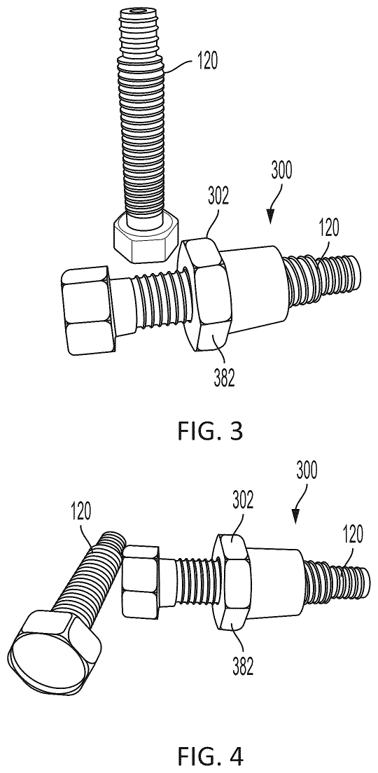

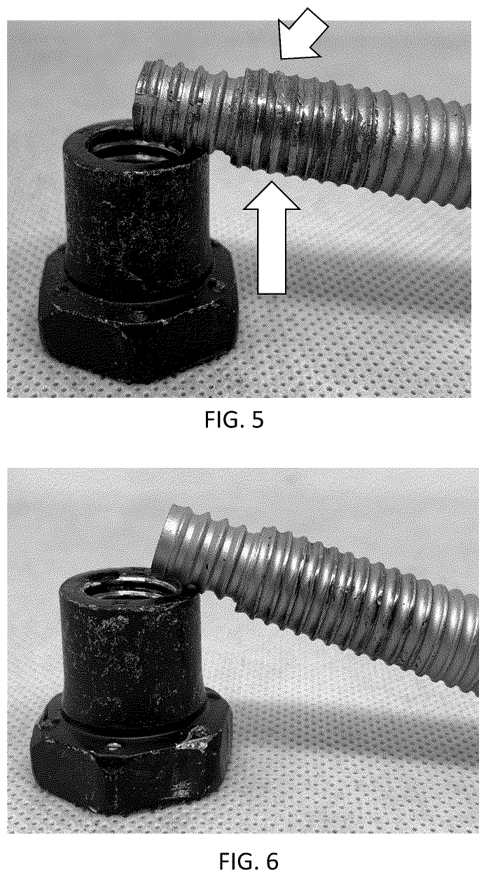

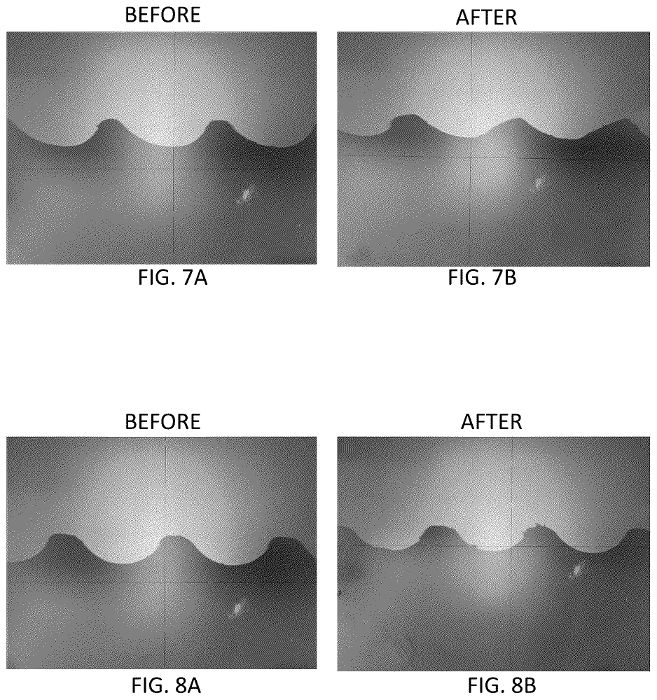

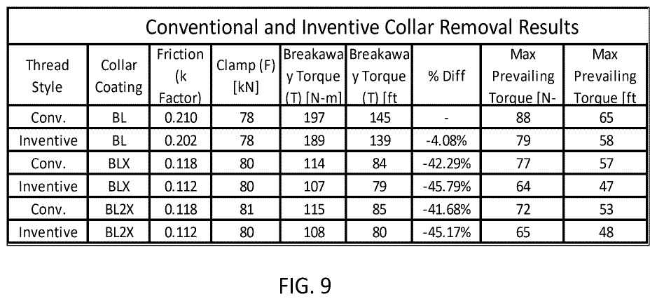

The shank 122 can comprise a shape suitable to be received within a cavity of a fastening collar (e.g., fastening collar 302 described with respect to FIG. 3). In various non-limiting embodiments, the shank 122 has a generally cylindrical shape. The shank 122 can be intermediate the first pin end 128 and the second pin end 130. The shank 122 can comprise threads 126, which can be configured to engage an inner collar surface of a fastening collar and form threads thereon. After formation of the threads thereon, the threads 126 and formed threads on the inner collar surface may have reduced galling during removal of an installed fastening collar compared to conventional threads.

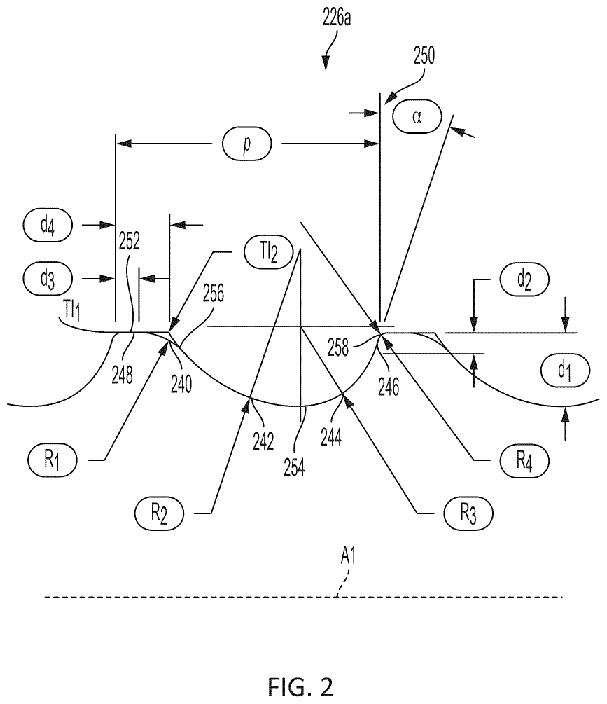

Referring to FIG. 2, the threads 126 (e.g., helical threads) can comprise a thread profile 226a comprising a first curved feature 240, a second curved feature 242, a third curved feature 244, a first linear feature 246, and a second linear feature 248. The thread profile 226a defines a geometry of the threads 126 that spans one pitch, p, and repeats along the threads 126.

In various non-limiting embodiments, at least one of the second curved feature 242 and the third curved feature 244 form a root 254 of the thread profile 226a. The root 254 can comprise the smallest diameter (e.g., root diameter) in the thread profile 226a. The root 254 can be defined by a line tangent to the thread profile 226a that can be no greater than 15 degrees from parallel to the longitudinal axis, A₁. In various non-limiting embodiments, a linear feature is not present in the root 254 and the root 254 is a continuous curve.

The first curved feature 240 extends along the longitudinal axis, A₁, and defines a first radius of curvature, R₁. The first curved feature 240 can be tangent to a crest 252 of the thread profile 226a and the second curved feature 242. The crest 252 can comprise the largest diameter (e.g., major diameter, nominal diameter of the fastener) in the thread profile 226a. The first radius of curvature, R₁, can be greater than 0 up to 0.45 times a second radius of curvature, R₂, of the second curved feature 242. In various non-limiting embodiments, the first radius of curvature, R₁, can be in a range of 0.015 inches to 0.035 inches, such as, for example, 0.0175 inches to 0.0185 inches, 0.02 inches to 0.022 inches, 0.022 inches to 0.026 inches, or 0.027 inches to 0.032 inches.

The second curved feature 242 extends along the longitudinal axis, A₁, can be adjacent to the first curved feature 240, and defines the second radius of curvature, R₂. The second curved feature 242 can be tangent to the root 254. In various non-limiting embodiments, the second radius of curvature, R₂, can be in a range of 0.04 inches to 0.08 inches, such as, for example, 0.042 inches to 0.046 inches, 0.048 inches to 0.052 inches, 0.055 inches to 0.06 inches, or 0.07 inches to 0.08 inches. The first curved feature 240 and the second curved feature 242 can form an inflection point 256 therebetween.

The third curved feature 244 extends along the longitudinal axis, A₁, can be adjacent the second curved feature 242, and defines a third radius of curvature, R₃. In various non-limiting embodiments, the second curved feature 242 is intermediate and adjacent the first curved feature 240 and the third curved feature 244. The third curved feature 244 can be tangent to the first linear feature 246 and can be tangent to the root 254. The third radius of curvature, R₃, can be defined according to the following Formula 1:

$${R}_{3} \leq \frac{0.015}{( 1 - sin ∝ )} \qquad Formula 1$$

wherein α is the flank angle as described below.

In various non-limiting embodiments, the third radius of curvature, R₃, can be in a range of 0.02 inches to 0.036 inches, 0.02 inches to 0.024 inches, 0.023 inches to 0.027 inches, 0.027 inches to 0.031 inches, or 0.033 inches to 0.038 inches.

The second radius of curvature, R₂, can be in a range of 1.5 times greater than the third radius of curvature, R₃, to 2.5 times greater than the third radius of curvature, R₃, such as, for example, in a range of 1.8 times greater than the third radius of curvature, R₃, to 2.2 times greater than the third radius of curvature, R₃, or a range of 1.9 times greater than the third radius of curvature, R₃, to 2.1 times greater than the third radius of curvature, R₃.

The first linear feature 246 extends along the longitudinal axis, A₁, can be adjacent the third curved feature 244, and comprises a flank angle, α. The flank angle, α, can be measured relative to a line, 250, perpendicular to the longitudinal axis, A₁ and towards the head portion 136. In various non-limiting embodiments, the flank angle, «, can be in a range of 0 degrees to 60 degrees, such as, for example, greater than 0 to 60 degrees, 5 degrees to 45 degrees, 10 degrees to 30 degrees, 10 degrees to 25 degrees, 15 degrees to 22 degrees, 18 degrees to 20 degrees, or 18.5 degrees to 19.5 degrees. In various non-limiting embodiments, the first linear feature 246 extends a distance, d₂, perpendicular to the longitudinal axis, A₁, in a range of 0.005 inches to 0.01 inches, such as, for example, 0.005 inches to 0.0065 inches, 0.0065 inches to 0.008 inches, 0.007 inches to 0.008 inches, or 0.009 inches to 0.01 inches.

The second linear feature 248 extends along the longitudinal axis, A₁, and can be at the crest 252. The second linear feature 248 can extend a distance, d₃, along the longitudinal axis in a range of 0.005 inches to 0.013 inches, such as, for example, 0.006 inches to 0.0075 inches, 0.0075 inches to 0.009 inches, 0.0085 inches to 0.01 inches, or 0.011 inches to 0.012 inches. The second linear feature can be adjacent to the first curved feature 240.

In various non-limiting embodiments, a fourth curved feature 258 can be intermediate and in contact with the first linear feature 246 and the second linear feature 248. The fourth curved feature 258 extends along the longitudinal axis, A₁, and has a fourth radius of curvature, R₄. The fourth radius of curvature, R₄, if present, can be in a range of greater than 0 times to 0.5 times a depth, d₁ (e.g., root depth).

In various non-limiting embodiments, the thread profile 226a can comprise a thread pitch, p, in a range of 0.07 inches to 0.140 inches, such as, for example, 0.07 inches to 0.08 inches, 0.085 inches to 0.09 inches, 0.095 inches to 0.11 inches, or 0.12 inches to 0.13 inches. In various non-limiting embodiments, the distance, d₃, can be at least 5% of the pitch, p, such as, for example, at least 10% of the pitch, p. In various non-limiting embodiments, the distance, d₃, can be in a range of 5% to 15% of the pitch, p. The pitch, p, can consist essentially of or consist of a linear distance along the longitudinal axis, A₁, occupied by the first curved feature 240, the second curved feature 242, the third curved feature 244, optionally the fourth curved feature 258, the first linear feature 246, and the second linear feature 248.

In various non-limiting embodiments, the thread profile 226a can comprise the depth, d₁, in a range of 0.018 inches to 0.040 inches, such as, for example, 0.018 inches to 0.022 inches, 0.022 inches to 0.026 inches, 0.026 inches to 0.030 inches, or 0.032 inches to 0.036 inches. In various non-limiting embodiments, a ratio of the depth, d₁, to the major diameter, d_{M}, can be in a range of 0.03 to 0.06, such as, for example, 0.035 to 0.050 or 0.04 to 0.045.

The first linear feature 246 and the second linear feature 248 can define a first imaginary intersection, Tl₁. The second curved feature 242 and the second linear feature 248 can define a second imaginary intersection, Tl₂. A distance, d₄, can extend from the first imaginary intersection, Tl₁, along the longitudinal axis, A₁, to the second imaginary intersection, Tl₂. In various non-limiting embodiments, a ratio of the distance, d₄, to the major diameter, d_{M}, can be in a range of 0.02 to 0.05, such as, for example, 0.025 to 0.04 or 0.03 to 0.035. In various non-limiting embodiments, a ratio of the pitch, p, to the distance, d₄, can be in a range of 4 to 6, such as, for example, 4.5 to 5.5, 4.5 to 5.25, or 4.7 to 5.0.

A multi-piece fastener can comprise the pin according to the present disclosure. The multi-piece fastener can be a lockbolt or a blind fastener. In various non-limiting embodiments, referring to FIGS. 3 and 4, a multi-piece fastener 300 according to the present disclosure can comprise a two-piece assembly including, for example, the fastening collar 302 and the pin 120. The fastening collar 302 can comprise a feature configured to receive a torque, such as, for example, a substantially flat side, a rib, a spline, an indent, a knurl, a lobe, a bore, a recess, a tab, and/or a similar structural feature. As illustrated in FIGS. 3 and 4, the fastening collar 302 comprises 6 flat sides 382 (e.g., a hex) that can be engaged by a standard off the shelf tool, such as, for example, an impact driver, a torque wrench, and/or standard driver with socket, and rotated about the longitudinal axis, A₁, of the pin 120 for removal.

The fastening collar 302 and/or the pin 120 can be sized as appropriate for the intended application. For example, referring to FIG. 1, the shank 122 can comprise a major diameter, d_{M}, in a range of 0.06 inch to 4 inches, and the fastening collar 302 can be sized to receive the shank 122. For example, in various non-limiting embodiments, the major diameter, d_{M}, can be 0.39 inches (10 mm), 0.47 inches (12 mm), 0.55 inches (14 mm), 0.63 inches (16 mm), or 0.79 inches (20 mm), with a deviation of +/−10%. In various non-limiting embodiments, a pitch, p, to major diameter, d_{M}, ratio of the pin 120 can be in a range of 2 to 4, such as, for example, 2.5 to 3.5, 2.8 to 3.2, or 2.9 to 3.1.

The fastener and its individual components as described herein can comprise any suitable material, such as, for example, a metal, a metal alloy, a polymer, or another suitable material.

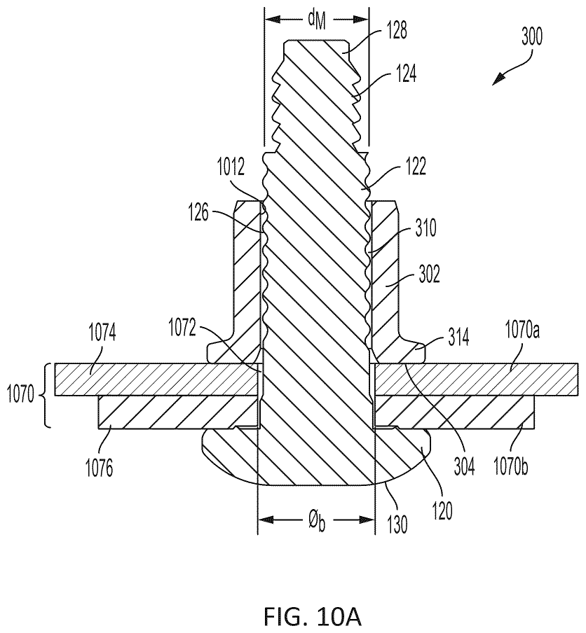

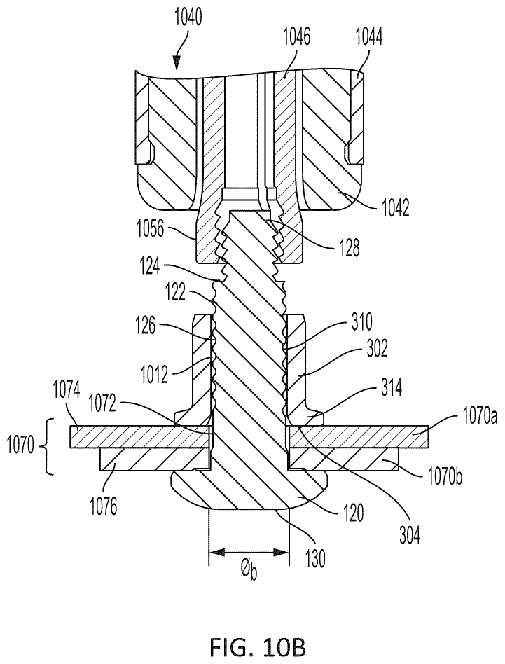

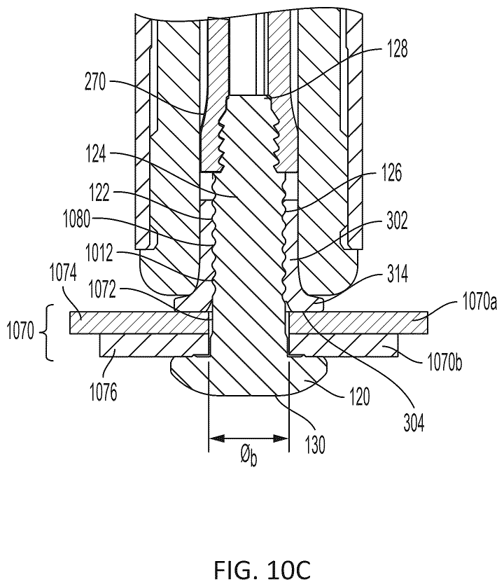

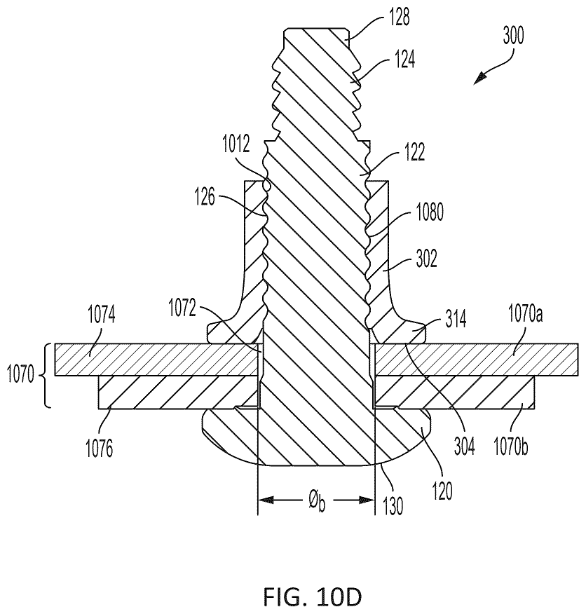

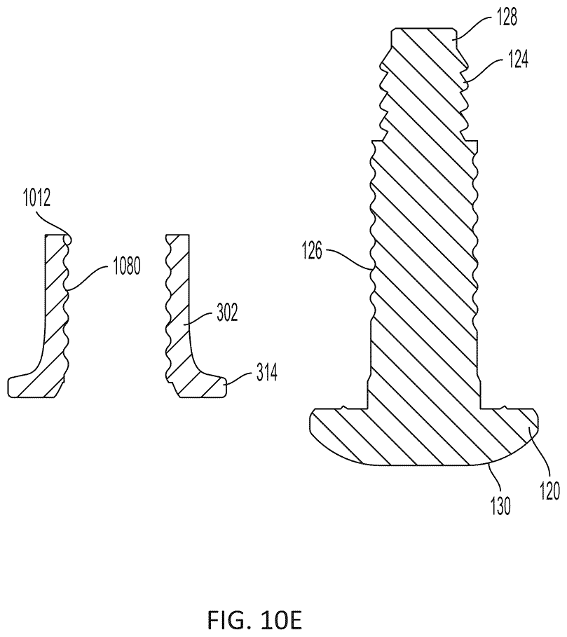

As illustrated in FIGS. 10A-10B, the multi-piece fastener 300 can be installed into a bore 1072 of a structure 1070. As illustrated, the bore 1072 can extend through the structure 1070 from a first side 1074 to a second side 1076.

The structure 1070 can comprise, for example, at least one of a metal, a metal alloy, a composite material, or another suitable material. For example, in certain non-limiting embodiments, the structure 1070 can comprise at least one of aluminum, an aluminum alloy, titanium, a titanium alloy, nickel, a nickel alloy, iron, an iron alloy, and a carbon fiber composite material. In various non-limiting embodiments, the structure 1070 into which the multi-piece fastener 300 is assembled comprises aluminum and/or an aluminum alloy, such as, for example, 7075 aluminum alloy. With reference to the accompanying figures, in various non-limiting embodiments the structure 1070 can be configured as at least one of an aerospace component or structure, an automotive component or structure, a transportation component or structure, a building and construction component or structure, or another component or structure.

The structure 1070 can comprise a single layer of material or at least two layers of material. For example, as illustrated in FIGS. 10A-10D, the structure 1070 can comprise a first layer 1070a and a second layer 1070b. The first layer 1070a can be intermediate the second layer 1070b and the fastening collar 302 when the fastening collar 302 is installed. In various non-limiting embodiments, the first layer 1070a is in contact with the fastening collar 302.

The bore 1072 can have a bore diameter, Øb. Additionally, to facilitate alignment of the multi-piece fastener 300 with the bore 1072, the major diameter, d_{M}, of the shank 122 can be sized and configured to be less than the bore diameter, Ø_{b}, thereby allowing the first pin end 128 to be readily disposed into and through the bore 1072. In various non-limiting embodiments, the bore diameter, Ø_{b}, can be less than a diameter of the head portion 136 in order to inhibit the head portion 136 of the pin 120 from moving into the bore 1072.

As illustrated in FIG. 10A, the first pin end 128 of the pin 120 was positioned in alignment with the bore 1072 on the second side 1076 of the structure 1070 before being inserted through the bore 1072. The fastening collar 302 has been positioned over the first pin end 128, and the first pin end 128 has been inserted into and through a collar cavity 310 of the fastening collar 302. A first collar end 304 of the fastening collar 302 has been positioned to contact the first layer 1070a of the structure 1070. For example, the fastening collar 302 can be in forcible contact with the structure 1070, which can limit further axial movement of the fastening collar 302 relative to the pin 120 along the longitudinal axis, A₁, of the multi-piece fastener 300. As illustrated in FIG. 10A, an inner surface 1012 of the fastening collar 302 is substantially smooth, defining the collar cavity 310. The inner surface 1012 may lacks threads. The fastening collar 302 can comprise a flange 314 configured to inhibit the fastening collar 302 from entering the bore 1072.

Referring to FIG. 10B, a collet 1046 of the fastening collar installation apparatus 1040 has engaged the shank 122 of the pin 120 of the multi-piece fastener 300. For example, the collet 1046 was positioned over the pull region 124 of the multi-piece fastener 300 and retracted within the housing 1044 of the fastening collar installation apparatus 1040, which has caused the collet 1046 to forcibly contact the anvil 1042 of the fastening collar installation apparatus 1040. Responsive to the contact between the anvil 1042 and the collet 1046, the jaws 1056 have closed around the pull region 124 and have forcibly contacted the pull region 124 of pin 120.

Upon engagement, the collet 1046 can apply an axial force to the pull region 124 of the pin 120, which can decrease a gap, if present, between the first layer 1070a and the second layer 1070b of the structure 1070 and create forcible contact between the fastening collar 302 and the structure 1070, and the head portion 136 and the structure 1070. For example, referring to FIG. 10C, the collet 1046 has further retracted within the fastening collar installation apparatus 1040 and moved the pin 120 due to the engagement between the pull region 124 and the collet 1046. As the collet 1046 retracts within the housing 1044 of the fastening collar installation apparatus 1040, the anvil 1042 can contact the fastening collar 302. After a predetermined force is achieved, the fastening collar 302 can be at least partially deformed responsive to the forcible contact between the anvil 1042 and the fastening collar 302. For example, the fastening collar 302 can be swaged onto a section of the threads 126 of the shank 122 intermediate the first layer 1070a and the first pin end 128. At least partially deforming the fastening collar 302 onto the shank 122 of the pin 120 can thereby secure the fastening collar 302 to the shank 122 and secure the multi-piece fastener 300 to at least a portion of the structure 1070. In that way, for example, the first layer 1070a and second layer 1070b of the structure 1070 are secured together (e.g., inhibited from axial movement along the longitudinal axis, A₁, of the multi-piece fastener 300).

As illustrated in the non-limiting embodiment shown in FIG. 10D, after installation of the multi-piece fastener 300 into the structure 1070, the fastening collar 302 and the head portion 136 of the pin 120 are applying a clamping force to the layers 1070a-b of the structure 1070, thereby securing the multi-piece fastener 300 to the structure 1070 and securing layers 1070a-b together. Additionally, threads 1080 have been formed on the inner surface 1012 of the fastening collar 302 as a result of the forcible contact from the collet 1046 of the fastening collar installation apparatus 1040. In various non-limiting embodiments, as illustrated in FIG. 10D, the pin 120 may not fracture after installation into the structure 1070.

Referring to FIG. 10E, the fastening collar 302 may be removed after installation with standard off the shelf removal methods, such as, for example, an impact driver, a torque wrench, and/or standard driver with socket. The threads 1080 and/or threads 126 may not gall after removal of the fastening collar 302.

The present disclosure includes methods for installing a fastener and fastening a structure, as described and illustrated herein. In various non-limiting embodiments, the multi-piece fastener systems according to the present disclosure can be used in a method for fastening a structure. A second end of a multi-piece fastener according to the present disclosure can be inserted into a bore in a structure. At least a portion of the second pin end can be passed through a collar cavity of a fastening collar of the multi-piece fastener according to the present disclosure. The pull region of the pin can be forcibly contacted with jaws of a collet of a fastening collar installation apparatus according to the present disclosure.

The fastening collar can be forcibly contacted with an anvil of the fastening collar installation apparatus. The pull region can be moved distal from the fastening collar utilizing the collet of the fastening collar installation apparatus according to the present disclosure. Thereby, the fastening collar installation apparatus deforms the fastening collar onto the shank of the pin and secures at least a portion of the multi-piece fastener according to the present disclosure in the structure. The deformation may form threads on the inner surface of the fastening collar. The fastening collar can be removed from the pin by applying a torque to the fastening collar. In various non-limiting embodiments, the fastening collar can be removed by applying a rotational torque to the fastening collar, and the threads of the pin may be minimally, if at all, galled during removal of the fastening collar. The fastening collar may be removed with standard off the shelf removal methods, such as, for example, an impact driver, a torque wrench, and/or standard driver with socket.

Various aspects of embodiments according to the present disclosure include, but are not limited to, the aspects listed in the following numbered clauses.
Clause 1. A fastener comprising: a pin comprising a first pin end, a second pin end, and a shank extending intermediate the first pin end and the second pin end, the shank comprising a longitudinal axis and threads including a thread profile comprising: a first curved feature extending along the longitudinal axis and defining a first radius of curvature, a second curved feature extending along the longitudinal axis and adjacent to the first curved feature, the first curved feature and the second curved feature forming an inflection point therebetween, the second curved feature defining a second radius of curvature, a third curved feature extending along the longitudinal axis and adjacent the second curved feature, the third curved feature defining a third radius of curvature, wherein at least one of the second curved feature and the third curved feature form a root of the thread profile, wherein the second radius of curvature is in a range of 1.5 times greater than the third radius of curvature to 2.5 times greater than the third radius of curvature, a first linear feature adjacent the third curved feature and defining a flank angle in a range of 0 degrees to 60 degrees, and a second linear feature extending along the longitudinal axis and positioned at a crest of the thread profile.
Clause 2. The fastener of clause 1, wherein the second radius of curvature is in a range of 1.8 times greater than the third radius of curvature to 2.2 times greater than the third radius of curvature.
Clause 3. The fastener of clause 1, wherein the second radius of curvature is in a range of 1.9 times greater than the third radius of curvature to 2.1 times greater than the third radius of curvature.
Clause 4. The fastener of any of clauses 1-3, wherein the third radius of curvature is in a range of 0.02 inches to 0.036 inches and is defined according to the following formula:

$${R}_{3} \leq \frac{0.015}{( 1 - sin ∝ )} ,$$

where α is the flank angle.
Clause 5. The fastener of any of clauses 1-4, wherein the thread profile further comprises a fourth curved feature intermediate and in contact with the first linear feature and the second linear feature, the fourth curved feature defining a fourth radius of curvature in a range of greater than 0 times to 0.5 times a root depth of the thread profile.
Clause 6. The fastener of any of clauses 1-5 wherein θ ratio of a root depth of the thread profile to a major diameter of the threads is in a range of 0.03 to 0.06.
Clause 7. The fastener of any of clauses 1-6 wherein a ratio of a thread pitch of the thread profile to a fourth distance is in a range of 4 to 6, wherein the fourth distance and is defined between a first imaginary intersection of the first linear feature and the second linear feature and a second imaginary intersection of the second curved feature and the second linear feature.
Clause 8. The fastener of clause 7, wherein a ratio of the fourth distance to a major diameter of the shank is in a range of 0.02 to 0.05.
Clause 9. The fastener of any of clauses 1-8 wherein the thread profile comprises a depth in a range of 0.018 inches to 0.040 inches.
Clause 10. The fastener of any of clauses 1-9 wherein: the first radius of curvature is in a range of 0.015 inches to 0.035 inches; the second radius of curvature is in a range of 0.04 inches to 0.08 inches; the third radius of curvature is in a range of 0.02 inches to 0.036 inches; the first linear feature extends a distance perpendicular to the longitudinal axis in a range of 0.005 inches to 0.01 inches; the second linear feature extends a distance along the longitudinal axis in a range of 0.005 inches to 0.013 inches; the thread profile comprises a thread pitch in a range of 0.07 inches to 0.140 inches; and the shank comprises a major diameter in a range of 0.47 inches to 0.79 inches+/−10%.
Clause 11. The fastener of any of clauses 1-10 wherein: the first radius of curvature is in a range of 0.0175 inches to 0.0185 inches; the second radius of curvature is in a range of 0.042 inches to 0.046 inches; the third radius of curvature is in a range of 0.02 inches to 0.024 inches; the first linear feature extends a distance perpendicular to the longitudinal axis in a range of 0.005 inches to 0.0065 inches; the second linear feature extends a distance along the longitudinal axis in a range of 0.006 inches to 0.0075 inches; the thread profile comprises a thread pitch in a range of 0.07 inches to 0.08 inches; and the shank comprises a major diameter of 0.47 inches+/−10%.
Clause 12. The fastener of any of clauses 1-10 wherein: the first radius of curvature is in a range of 0.02 inches to 0.022 inches; the second radius of curvature is in a range of 0.048 inches to 0.052 inches; the third radius of curvature is in a range of 0.023 inches to 0.027 inches; the first linear feature extends a distance perpendicular to the longitudinal axis in a range of 0.0065 inches to 0.008 inches; the second linear feature extends a distance along the longitudinal axis in a range of 0.0075 inches to 0.009 inches; the thread profile comprises a thread pitch in a range of 0.085 inches to 0.09 inches; and the shank comprises a major diameter of 0.55 inches+/−10%.
Clause 13. The fastener of any of clauses 1-10 wherein: the first radius of curvature is in a range of 0.022 inches to 0.026 inches; the second radius of curvature is in a range of 0.055 inches to 0.06 inches; the third radius of curvature is in a range of 0.027 inches to 0.031 inches; the first linear feature extends a distance perpendicular to the longitudinal axis in a range of 0.007 inches to 0.008 inches; the second linear feature extends a distance along the longitudinal axis in a range of 0.0085 inches to 0.01 inches; the thread profile comprises a thread pitch in a range of 0.095 inches to 0.11 inches; and the shank comprises a major diameter of 0.63 inches+/−10%.
Clause 14. The fastener of any of clauses 1-10 wherein: the first radius of curvature is in a range of 0.027 inches to 0.032 inches; the second radius of curvature is in a range of 0.07 inches to 0.08 inches; the third radius of curvature is in a range of 0.033 inches to 0.038 inches; the first linear feature extends a distance perpendicular to the longitudinal axis in a range of 0.009 inches to 0.01 inches; the second linear feature extends a distance along the longitudinal axis in a range of 0.011 inches to 0.012 inches; the thread profile comprises a thread pitch in a range of 0.12 inches to 0.13 inches; and the shank comprises a major diameter of 0.79 inches+/−10%.
Clause 15. The fastener of any of clauses 1-14, wherein the shank comprises a major diameter in a range of 0.06 inch to 4 inches.
Clause 16. The fastener of any of clauses 1-15, wherein the fastener comprises a metal, a metal alloy, a polymer, or a combination thereof.
Clause 17. The fastener of any of clauses 1-16, further comprising a fastening collar configured to receive the pin.
Clause 18. The fastener of clause 17, wherein the fastening collar comprises a substantially smooth inner surface defining a collar cavity.
Clause 19. A method for fastening, the method comprising: inserting a pin end of the pin of the fastener of clause 17 or clause 18 into a bore of a structure; and forcibly contacting an elongate portion of the fastening collar of the fastener with a contact surface of an installation tool, thereby forcibly contacting the structure with a collar end of the fastening collar and deforming the elongate portion onto threads of the pin.
Clause 20. The method of clause 19, further comprising removing the fastening collar from the pin by applying a torque to the fastening collar.

One skilled in the art will recognize that the fasteners, pins, fastening collars, structures, methods, operations/actions, and objects described herein, and the accompanying discussion, are non-limiting examples presented for the sake of conceptual clarity and that various modifications to the disclosed configurations are contemplated. Consequently, as used herein, the specific examples/embodiments set forth, and the accompanying discussion, are intended to be representative of their more general classes. In general, use of any specific exemplar is intended to be representative of its class and the non-inclusion of specific components, devices, apparatus, operations/actions, and objects should not be taken as limiting. While the present disclosure provides descriptions of various specific aspects for the purpose of illustrating various aspects of the present disclosure and/or its potential applications, it is understood that variations and modifications will occur to those skilled in the art. Accordingly, the invention or inventions described herein should be understood to be at least as broad as they are claimed and not as more narrowly defined by particular illustrative aspects provided herein.

Any references herein to “various embodiments”, “some embodiments”, “one embodiment”, “an embodiment”, a “non-limiting embodiment”, or like phrases mean that a particular feature, structure, or characteristic described in connection with the example is included in at least one embodiment. Thus, appearances of the phrases “in various embodiments”, “in some embodiments”, “in one embodiment”, “in an embodiment”, “in a non-limiting embodiment”, or like phrases in the specification do not necessarily refer to the same embodiment. Furthermore, the particular described features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation. Such modifications and variations are intended to be included within the scope of the present embodiments.

In this specification, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Also, any numerical range recited herein includes all sub-ranges subsumed within the recited range. For example, a range of “1 to 10” includes all sub-ranges between (and including) the recited minimum value of 1 and the recited maximum value of 10, that is, having a minimum value equal to or greater than 1 and a maximum value equal to or less than 10. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

The grammatical articles “a”, “an”, and “the”, as used herein, are intended to include “at least one” or “one or more”, unless otherwise indicated, even if “at least one” or “one or more” is expressly used in certain instances. Thus, the foregoing grammatical articles are used herein to refer to one or more than one (i.e., to “at least one”) of the particular identified elements. Further, the use of a singular noun includes the plural, and the use of a plural noun includes the singular, unless the context of the usage requires otherwise.

What is claimed is:

1. A fastener comprising:
a pin comprising
a first pin end,
a second pin end, and
a shank extending intermediate the first pin end and the second pin end, the shank comprising a longitudinal axis and threads including a thread profile comprising:
a first curved feature extending along the longitudinal axis and defining a first radius of curvature;
a second curved feature extending along the longitudinal axis and adjacent to the first curved feature, the first curved feature and the second curved feature forming an inflection point therebetween, the second curved feature defining a second radius of curvature;
a third curved feature extending along the longitudinal axis and adjacent the second curved feature, the third curved feature defining a third radius of curvature, wherein at least one of the second curved feature and the third curved feature form a root of the thread profile, wherein the second radius of curvature is in a range of 1.5 times greater than the third radius of curvature to 2.5 times greater than the third radius of curvature;
a first linear feature adjacent the third curved feature and defining a flank angle in a range of 0 degrees to 60 degrees; and
a second linear feature extending along the longitudinal axis and at a crest of the thread profile.

2. (canceled)

3. The fastener of claim 1, wherein the second radius of curvature is in a range of 1.9 times greater than the third radius of curvature to 2.1 times greater than the third radius of curvature.

4. The fastener of claim 1, wherein the third radius of curvature is in a range of 0.02 inches to 0.036 inches and is defined according to the following formula:
$${R}_{3} \leq \frac{0.015}{( 1 - sin [ [ 〚 ] ] \_ ( ∝ ) \_ ) [ [ 〚 ] ]} ,$$
wherein α is the flank angle.

5. The fastener of claim 1, wherein the thread profile further comprises a fourth curved feature intermediate and in contact with the first linear feature and the second linear feature, the fourth curved feature defining a fourth radius of curvature in a range of greater than 0 times to 0.5 times a root depth of the thread profile.

6. The fastener of claim 1 wherein a ratio of a root depth of the thread profile to a major diameter of the threads is in a range of 0.03 to 0.06.

7. The fastener of claim 1 wherein a ratio of a thread pitch of the thread profile to a fourth distance is in a range of 4 to 6, wherein the fourth distance and is defined between a first imaginary intersection of the first linear feature and the second linear feature and a second imaginary intersection of the second curved feature and the second linear feature.

8. (canceled)

9. The fastener of claim 1 wherein the thread profile comprises a depth in a range of 0.018 inches to 0.040 inches.

10. (canceled)

11. The fastener of claim 1 wherein:
the first radius of curvature is in a range of 0.0175 inches to 0.0185 inches;
the second radius of curvature is in a range of 0.042 inches to 0.046 inches;
the third radius of curvature is in a range of 0.02 inches to 0.024 inches;
the first linear feature extends a distance perpendicular to the longitudinal axis in a range of 0.005 inches to 0.0065 inches;
the second linear feature extends a distance along the longitudinal axis in a range of 0.006 inches to 0.0075 inches;
the thread profile comprises a thread pitch in a range of 0.07 inches to 0.08 inches; and
the shank comprises a major diameter of 0.47 inches+/−10%.

12. The fastener of claim 1 wherein:
the first radius of curvature is in a range of 0.02 inches to 0.022 inches;
the second radius of curvature is in a range of 0.048 inches to 0.052 inches;
the third radius of curvature is in a range of 0.023 inches to 0.027 inches;
the first linear feature extends a distance perpendicular to the longitudinal axis in a range of 0.0065 inches to 0.008 inches;
the second linear feature extends a distance along the longitudinal axis in a range of 0.0075 inches to 0.009 inches;
the thread profile comprises a thread pitch in a range of 0.085 inches to 0.09 inches; and
the shank comprises a major diameter of 0.55 inches+/−10%.

13. The fastener of claim 1 wherein:
the first radius of curvature is in a range of 0.022 inches to 0.026 inches;
the second radius of curvature is in a range of 0.055 inches to 0.06 inches;
the third radius of curvature is in a range of 0.027 inches to 0.031 inches;
the first linear feature extends a distance perpendicular to the longitudinal axis in a range of 0.007 inches to 0.008 inches;
the second linear feature extends a distance along the longitudinal axis in a range of 0.0085 inches to 0.01 inches;
the thread profile comprises a thread pitch in a range of 0.095 inches to 0.11 inches; and
the shank comprises a major diameter of 0.63 inches+/−10%.

14. The fastener of claim 1 wherein:
the first radius of curvature is in a range of 0.027 inches to 0.032 inches;
the second radius of curvature is in a range of 0.07 inches to 0.08 inches;
the third radius of curvature is in a range of 0.033 inches to 0.038 inches;
the first linear feature extends a distance perpendicular to the longitudinal axis in a range of 0.009 inches to 0.01 inches;
the second linear feature extends a distance along the longitudinal axis in a range of 0.011 inches to 0.012 inches;
the thread profile comprises a thread pitch in a range of 0.12 inches to 0.13 inches; and
the shank comprises a major diameter of 0.79 inches+/−10%.

15-18. (canceled)

19. A method for fastening, the method comprising:
inserting a pin end of the pin of the fastener of claim 1 into a bore of a structure, wherein the fastener further comprises a fastening collar; and
forcibly contacting an elongate portion of the fastening collar of the fastener with a contact surface of an installation tool, thereby forcibly contacting the structure with a collar end of the fastening collar and deforming the elongate portion onto threads of the pin.

20. (canceled)

21. A pin for installation and removal of a fastening collar, the pin comprising:
a shank including first threads configured to engage an inner surface of the fastening collar to form second threads thereon after installation by swaging of the fastening collar onto the first threads,
wherein the fastening collar is removable from the pin after the installation by application of a torque, and
wherein a thread profile of the first threads is configured to prevent galling of the first threads and the second threads in such a way the fastening collar is capable to be removed from the pin after installation by application of a torque.

22. The pin of claim 21, wherein the fastening collar is capable to be removed from the pin after installation using a removal methods selected from the group consisting of an impact driver, a torque wrench, a standard driver with socket, and a combination thereof.

23. The pin of claim 21, wherein the first threads include a thread profile capable to enable the removal of the fastening collar through conventional methods, without a need to cut or grind the fastening collar.

24. The pin of claim 21, wherein the first threads include a thread profile capable to reduce galling of the first threads compared to a comparative shank that does not include the thread profile.

25. The pin of claim 21, wherein the installation causes direct metal-to-metal contact between the fastening collar and the shank to reduce loosening effects of transverse vibrations and the first threads include a thread profile configured to prevent galling after formation of the direct metal-to-metal contact.

26. The pin of claim 21, wherein the pin comprises a pull region configured to receive an axial force during swaging of the fastening collar.

27. The pin of claim 21, wherein the shank comprises a generally cylindrical shape.

28. A pin for installation and removal of a fastening collar, the pin comprising:
a shank including first threads configured to engage an inner surface of the fastening collar to form second threads thereon after installation by swaging of the fastening collar onto the first threads,
wherein swaging the fastening collar onto the first threads reduces loosening effects of transverse vibrations;
wherein a thread profile of the first threads is configured to prevent galling of the first threads and the second threads in such a way the fastening collar is removable from the pin after installation by application of a torque.
